(19) United States
(12) Patent Application Publication
(10) Pub. No.: US 2026/0061540 A1
(43) Pub. Date: Mar. 5, 2026

(54) TOOL MANAGEMENT SYSTEM

(71) Applicant: OKUMA CORPORATION, Niwa-Gun (JP)

(72) Inventor: Shinya NOGUCHI, Niwa-Gun (JP)

(73) Assignee: OKUMA CORPORATION, Niwa-Gun (JP)

(21) Appl. No.: 19/304,660

(22) Filed: Aug. 20, 2025

(30) Foreign Application Priority Data
Sep. 5, 2024 (JP) 2024-153392

(51) Int. Cl. B23Q 17/09

(52) U.S. Cl. CPC B23Q 17/0995

(57) ABSTRACT

A tool management system includes a tool management device and an information input/output unit. In the information input/output unit, the tool component and/or the assembled tool stored in the tool information database in which unique identification information is assigned is selectable together with a plurality of predetermined action patterns representing actual operations necessary for preparing an assembled tool used in machining. The tool management device includes a list generating unit and a data determining unit. The list generating unit automatically generates a preparation tool list including the selected tool component and/or assembled tool for each of the action patterns when the tool component and/or the assembled tool is selected together with each of the action patterns. The data determining unit determines whether the unique identification information of the actual tool component and/or assembled tool matches the unique identification information listed in the preparation tool list or not.

### CROSS REFERENCE TO RELATED APPLICATION

This application claims the benefit of Japanese Patent Application Number 2024-153392 filed on September 5, 2024, the entirety of which is incorporated by reference.

### FIELD OF THE INVENTION

The disclosure relates to a system for controlling a tool used in machining with a machine tool.

### BACKGROUND OF THE INVENTION

In a numerical control machine tool that performs a cutting work, an NC program is preliminarily created, and a tool mounted on the machine is used to perform a cutting work of a workpiece. As a method for creating the NC program, there is a method that a machine operator types NC syntaxes using an input device includes a keyboard. Also, there is a method that a programmer uses a program creating device, such as CAD/CAM. The programmer creates the NC program assuming that a tool mounted in a magazine or a tool prepared in a factory, such as a tool room, will be used. Then, the programmer passes the NC program together with a tool list for use listing the tools necessary for executing the NC program to a machine operator. The machine operator prepares tools according to the tool list for use, stores the tools in the magazine, and performs a cutting work.

As an assistive means for such preparing tools, WO 2015/29232 discloses a tool management system that includes a tool management device including a tool retrieval unit, a tool database including a list of all the tools prepared in the factory, and a tool list for use as a list of tools necessary for executing the NC program. The tool management system generates a stand-by tool list as a list of the tools housed in the tool room and the tool magazine. Then, when the tools listed in the tool list for use and the tools listed in the stand-by tool list do not match, the tool retrieval unit generates a tool candidate list in accordance with retrieval conditions and the tool candidate list is displayed on the display unit.

The tools managed by the tool management system are used as illustrated in FIG. 10, where a cutting tool t, such as an end mill or a drill, is assembled to a holder referred to as a tool holder HL. Here, a tool AS, which is the cutting tool t in a state of being assembled to the tool holder HL, is referred to as an "assembled tool." In some cases, the cutting tool t mounted on the tool holder HL via an adapter, such as a collet, is referred to as the assembled tool.

As a disclosure according to managing the assembled tool, JP 2021-142613 A discloses a method that assigns code information for identifying a tool ID as a unique identifier to a tool holder, and manages a tool number by associating the tool number with a machining number used in a machining program.

A common problem to the disclosures of WO 2015/29232 and JP 2021-142613 A is as follows.

When processed products are relatively few in type or when there are many similar workpieces, an operation in which the tools are stored as the assembled tool so as not to change a tool configuration is possible, but in the case with small lot multi-product production, a range of processing types is wide, and types of tools are increased by the range of processing types. Therefore, it is difficult to store everything as the assembled tool from the aspects of cost and space for storage, and the operation replaces and uses the tool components including cutting tools and adapters from the tool holder as necessary. In this case, the disassembled cutting tool is often replaced and attached onto another tool holder as needed, and it is difficult to record what kind of cutting tools are assembled to the respective tool holders. Thus, as the result of repeating the replacement of each tool component, a location of each tool component is eventually unknown, thereby causing a problem of, for example, a wasted time looking for a desired tool component.

Therefore, it is an objective of the disclosure to provide a tool management system that is able to obtain a configuration of an assembled tool necessary for machining and a location thereof, even when the system manages the assembled tool, and thus, allows for reliably preparing a necessary assembled tool in a short time.

### SUMMARY OF THE INVENTION

In order to solve the above-described problem, the present disclosure provides a tool management system that includes a tool management device and an information input/output unit. The tool management device has a tool information database that stores information relating to an assembled tool assembled at least including a tool holder and a cutting tool as tool components, information relating to each of the tool components, and information relating to locations to store the assembled tool and each of the tool components. The information input/output unit is able to input/output data to/from the tool management device. When each piece of unique identification information assigned to each of the tool components, the assembled tool, and each of the locations to store is input via the information input/output unit, the tool management device stores each piece of the unique identification information in the tool information database by associating each piece of the unique identification information to each of the tool components, the assembled tool, or each of the locations to store. In the information input/output unit, the tool component and/or the assembled tool stored in the tool information database is selectable together with a plurality of predetermined action patterns representing actual operations necessary for preparing an assembled tool used in machining with a machine tool. The tool management device includes a list generating unit and a data determining unit. The list generating unit automatically generates a preparation tool list including the selected tool component and/or assembled tool for each of the action patterns when the tool component and/or the assembled tool is selected together with each of the action patterns by the information input/output unit. The data determining unit determines whether the unique identification information of the actual tool component and/or assembled tool input by the information input/output unit matches the unique identification information of the tool component and/or the assembled tool listed in the preparation tool list or not.

In another aspect of the disclosure, which is in the above-described configuration, the action patterns are, at least, i) removal of the assembled tool not to be used from the machine tool, ii) storage of the tool component and/or the assembled tool in the location to store, iii) collection of the tool component and/or the assembled tool, iv) assembly of each of the tool components to form the assembled tool, and v) loading of the assembled tool to the machine tool. Furthermore, the list generating unit automatically generates a removal list when the action pattern selected by i), a storage list when the action pattern selected by ii), a collection list when the action pattern selected by iii), an assembly list when the action pattern selected by iv), and a loading list when the action pattern selected by v), as the respective preparation tool lists.

In another aspect of the disclosure, which is in the above-described configuration, the tool information database includes a cutting tool information table that at least stores service life information of the cutting tool, and a tool configuration information table that stores information relating to the assembled tool. When the cutting tool is assembled to the tool holder, and the assembled tool is formed, the service life information stored in the cutting tool information table is copied in the tool configuration information table, the copied service life information is updated corresponding to a used time or a count of use as the assembled tool, and when the cutting tool is removed from the tool holder, the service life information of the cutting tool information table is updated corresponding to the service life information updated on the tool configuration information table.

The disclosure allows for precisely performing the actual operation of converting the assembled tool and its tool components, and the location to store into data by respectively assigning the unique identification information, generating the preparation tool list by selecting the predetermined action pattern on the data when the NC program is created, and preparing the assembled tool based on the preparation tool list while comparing a movement origin with a movement destination by means of the unique identification information. Accordingly, even when the system manages the assembled tool, the configuration of the assembled tool necessary for machining and the location thereof are obtainable, and thus, the necessary assembled tool is reliably preparable in a short time.

In addition to the above-described effect, another aspect of the disclosure allows for easily obtaining the operation necessary for the assembled tool and the tool component that need to move in each list because the list generating unit automatically generates the removal list when the action pattern is the removal, the storage list when the action pattern is the storage, the collection list when the action pattern is the collection, the assembly list when the action pattern is the assembly, and the loading list when the action pattern is the loading as the respective preparation tool lists.

In addition to the above-described effects, with another aspect of the disclosure, when the cutting tool is assembled to the tool holder, and an assembled tool is formed, the service life information in the cutting tool information table is copied in the tool configuration information table and is updated, and when the cutting tool is removed from the tool holder, the service life information of the cutting tool information table is updated corresponding to the service life information updated in the tool configuration information table. Accordingly, even though the cutting tool is replaced, the service life information is succeeded, thus allowing for accurate service life management.

### BRIEF DESCRIPTION OF THE DRAWINGS

FIG.1A and FIG.1B are a block diagram of a tool management system.

FIG. 2 is a flowchart of an assembly operation of assembling tool components to form an assembled tool.

FIG. 3 is a flowchart of a storage operation of storing the assembled tool in a location to store.

FIG. 4 is a flowchart of a preparation tool list generating operation.

FIG. 5 is a flowchart of the preparation tool list generating operation.

FIG. 6 is a flowchart of an operation of forming a new assembled tool.

FIG.7A to FIG.7B are an explanatory view illustrating a tool list for use and a preparation tool list, and movements of the assembled tool and the tool components between the lists.

FIG. 8 is a flowchart of a removal operation of the assembled tool.

FIG.9A and FIG.9B are a block diagram of a tool management system of a modification.

FIG. 10 is an explanatory view of the assembled tool.

### DETAILED DESCRIPTION OF THE INVENTION

The following describes embodiments of the disclosure based on the drawings.

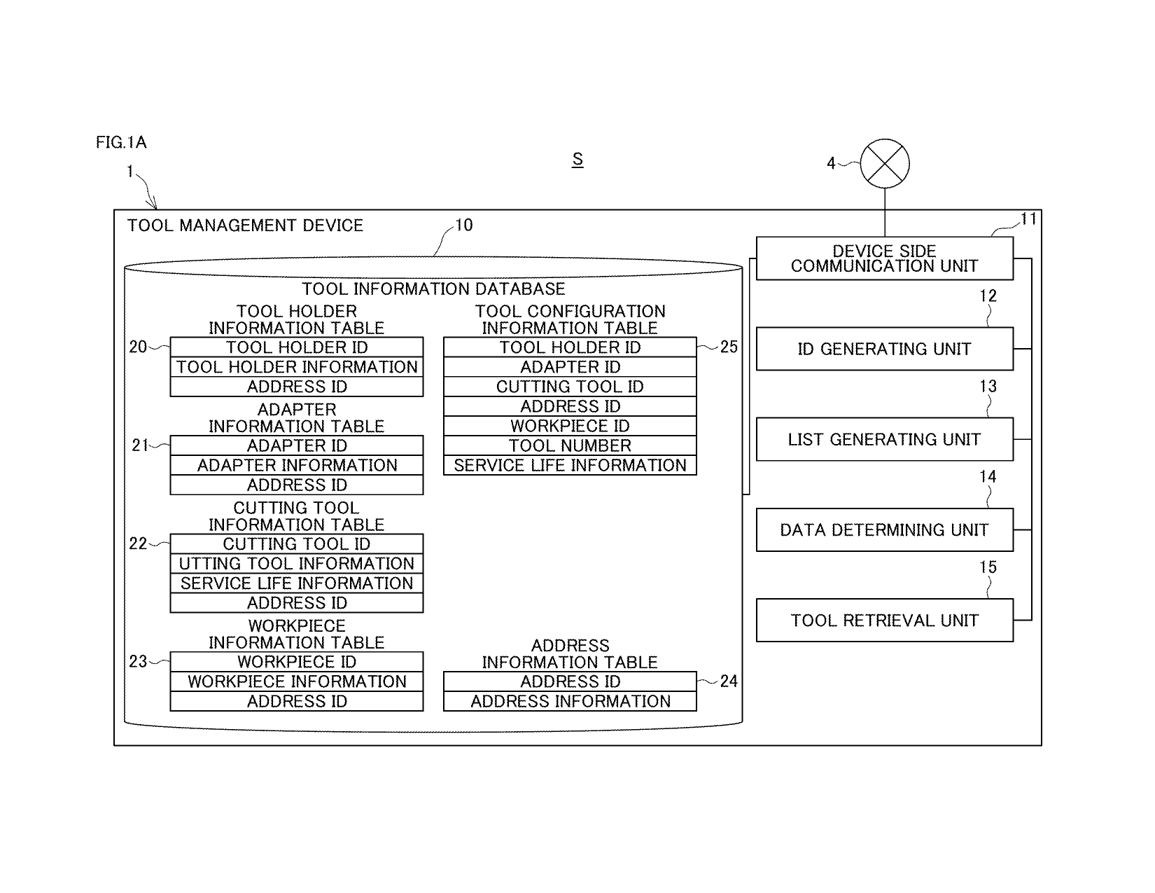

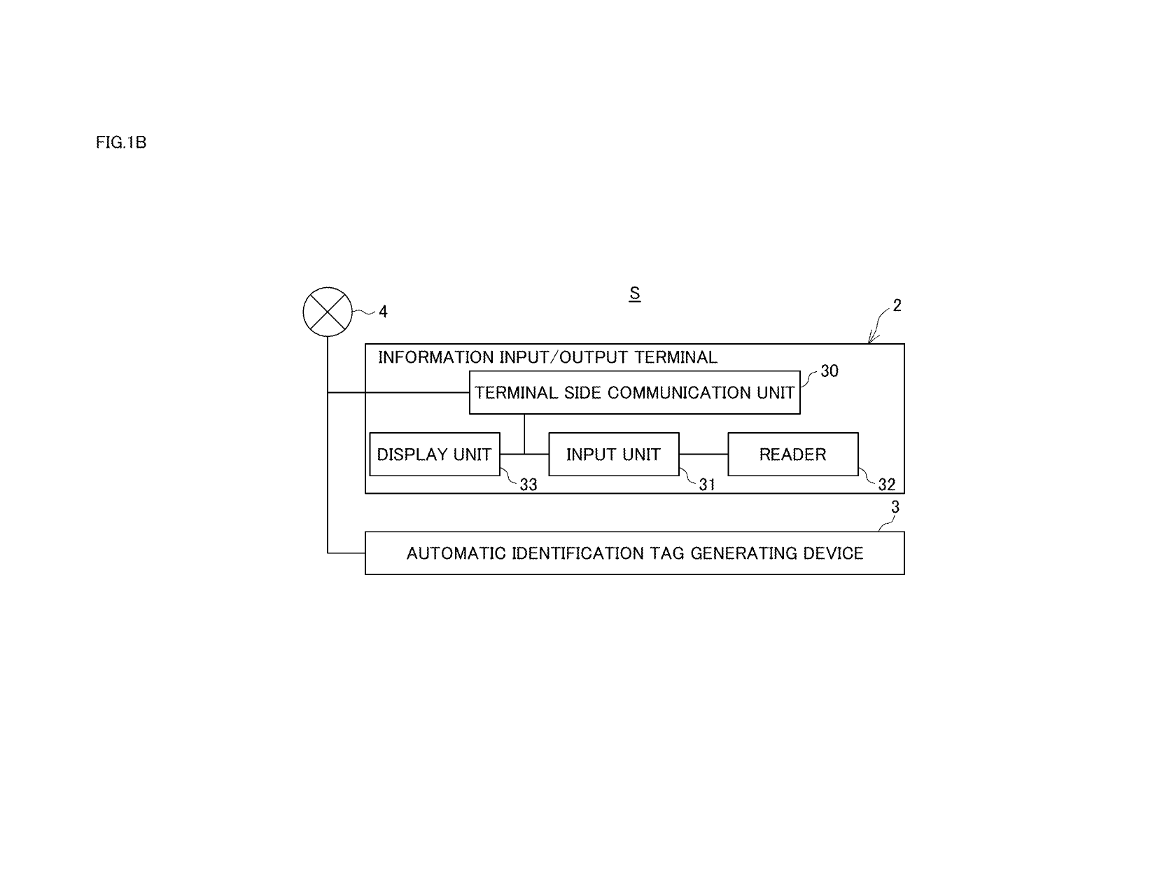

FIG.1A and FIG.1B are a block diagram illustrating an exemplary tool management system of the disclosure.

A tool management system (hereinafter simply referred to as a "system") S includes a tool management device 1, an information input/output terminal 2, an automatic identification tag generating device 3, and a network 4.

The tool management device 1 includes a tool information database 10, a device side communication unit 11, an ID generating unit 12, a list generating unit 13, a data determining unit 14, and a tool retrieval unit 15 as configuration units. The tool management device 1 is configured of a computer including a CPU and a memory coupled to the CPU, and the CPU and the memory achieve operations of the ID generating unit 12, the list generating unit 13, the data determining unit 14, and the tool retrieval unit 15.

The tool information database 10 is constituted of a tool holder information table 20, an adapter information table 21, a cutting tool information table 22, a workpiece information table 23, an address information table 24, and a tool configuration information table 25.

The information input/output terminal 2 includes a terminal side communication unit 30, an input unit 31, a reader 32, and a display unit 33 as configuration units. The information input/output terminal 2 is constituted including a CPU and a memory coupled to the CPU, and, for example, a computer or a mobile terminal is used for the information input/output terminal 2. The information input/output terminal 2 may interpret input data with another personal computer coupled to the network 4. A plurality of the information input/output terminals 2 may be present. The information input/output terminal 2 is an exemplary information input/output unit of the disclosure.

The automatic identification tag generating device 3 may, for example, be a label printer.

The network 4 enables a communication between the tool management device 1, the information input/output terminal 2, and the automatic identification tag generating device 3. The network 4 may be, what is called, a LAN, or may use the internet, or may be wired or wireless.

The tool holder information table 20 stores a tool holder ID as unique identification information of a tool holder, tool holder information as information relating to a tool holder, such as a model, and an address ID as information relating to a location to store.

The adapter information table 21 stores an adapter ID as unique identification information of an adapter, adapter information as information relating to an adapter, such as a type, for example, a collet, an address ID as information relating to a location to store.

The cutting tool information table 22 stores a cutting tool ID as unique identification information of a cutting tool, cutting tool information as information relating to a cutting tool, such as a tool diameter and a tool type, service life information as information relating to a service life of a cutting tool, and an address ID as information relating to a location to store.

The workpiece information table 23 stores a workpiece ID as unique identification information of a workpiece, workpiece information as information relating to a workpiece, such as a product number, a material, and prime contractor information, and an address ID as information relating to a location to store.

The address information table 24 stores an address ID as unique identification information of a location to store, and address information as information relating to a location to store, for example, a fixture, such as a cabinet and a tool rack, and a magazine of a machine tool.

The tool configuration information table 25 stores a tool number used for the assembled tool in the machine tool and service life information of a cutting tool, in addition to the tool holder ID, the adapter ID, and the cutting tool ID, which are information relating to the tool components constituting the assembled tool, and the address ID and the workpiece ID, which are information relating to the location to store the assembled tool.

The service life information of the cutting tool stored in the cutting tool information table 22 is copied into the service life information of the tool configuration information table 25 when assembled to the tool holder. The copied service life information is updated corresponding to a used time or a count of use used as the assembled tool. Thereafter, when the cutting tool is removed from the tool holder, the service life information of the cutting tool information table is updated corresponding to the service life information updated in the tool configuration information table 25.

In the system S, as an initial registration operation, unique identification information is assigned to a tool component, such as a tool holder, an adapter, and a cutting tool. Unique identification information is also assigned to fixtures and a machine tool that may serve as locations to store a workpiece to be processed and a tool component, and an assembled tool to which the tool components are assembled. For each piece of the unique identification information, a label is issued using, for example, a one-dimensional barcode or a two-dimensional barcode, an RFID, or characters, as an automatic identification tag from the automatic identification tag generating device 3 when an operator enters input from the input unit 31. The unique identification information is assigned by attaching the label on each. The labels are directly attached to the adapters and the cutting tools, or the labels are attached to casings that house the adapters and the cutting tools. For the locations to store, for example, the unique identification information may be assigned to the fixture alone, but when more certain location management is desired, it is allowed to assign the unique identification information to a drawer or a partition, or a casing or the like that houses the tool component or the assembled tool alone.

Each pieces of assigned unique identification information is transmitted to the device side communication unit 11 of the tool management device 1 via the terminal side communication unit 30. Accordingly, a record is generated for each of the information tables and the address information table of each of the tool components and the workpieces to be processed of the tool information database 10.

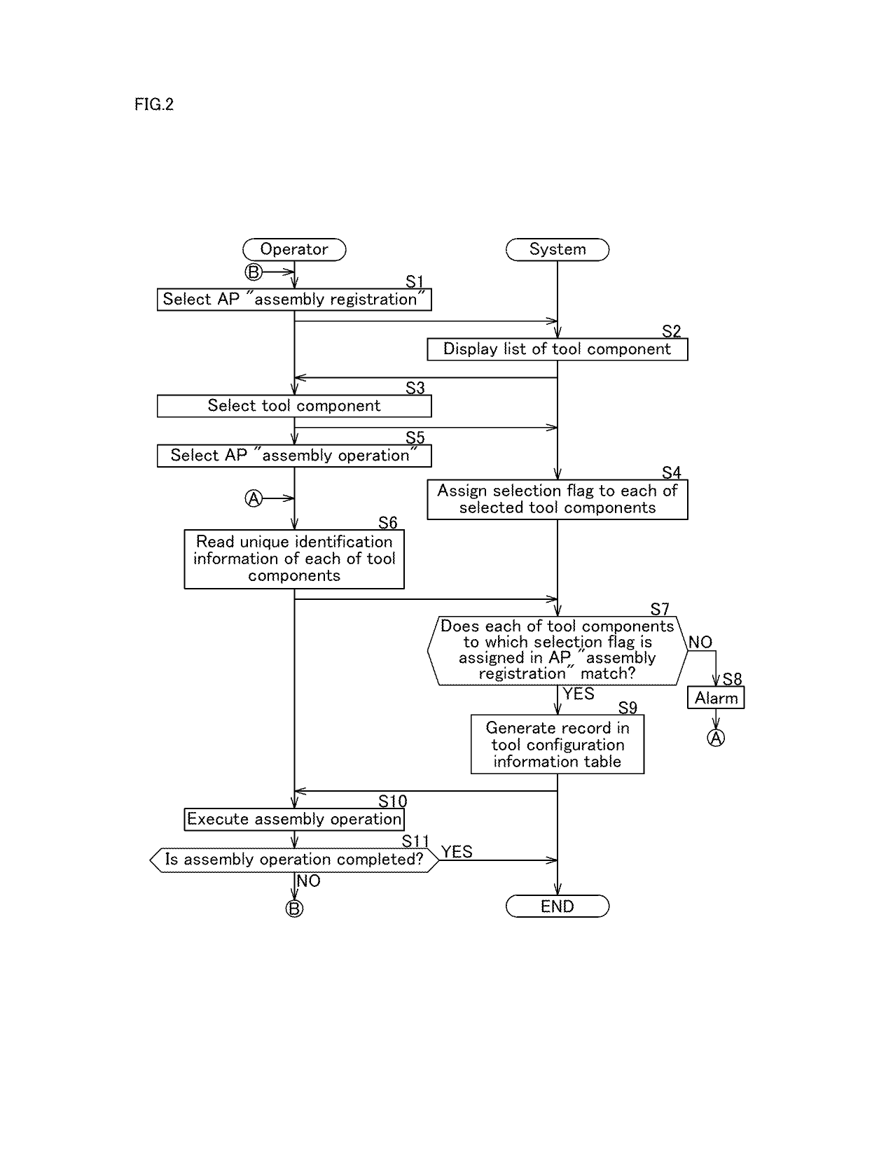

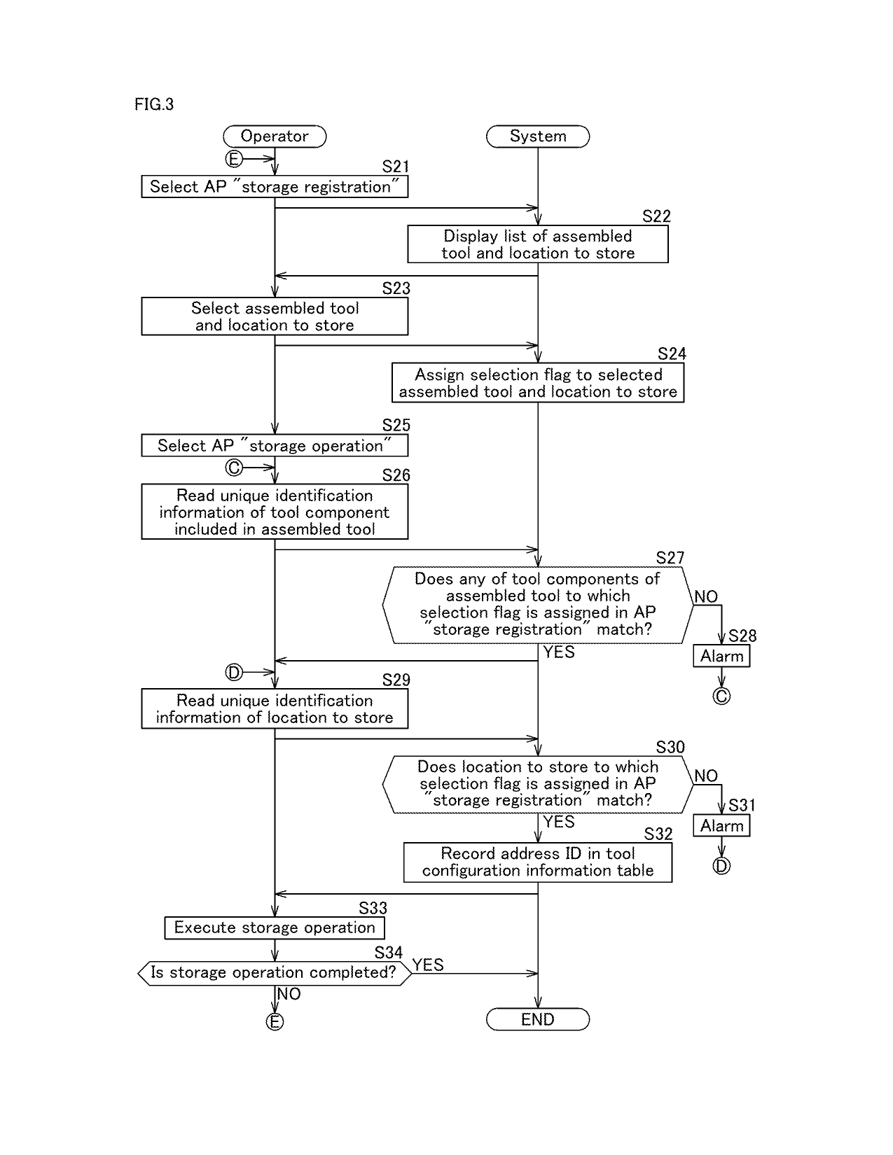

Next, the operation and the process in the system S when the assembled tool is formed by assembling the tool components that have completed the initial registration operation will be described based on the flowchart in FIG. 2.

First, the operator selects "assembly registration" as an action pattern (hereinafter abbreviated as "AP" in the drawings) from the input unit 31 of the information input/output terminal 2 at Step (hereinafter noted as "S") 1.

Then, in the system S, the list generating unit 13 generates a list of the registered tool components for each of tool holder, adapter, and cutting tool, and displays the list on the display unit 33 at S2.

Accordingly, the operator can select the tool holder, the adapter, and the v that are planned to be assembled as the assembled tool on the list at S3.

As soon as the selection of the tool holder, the adapter, and the cutting tool planned to be assembled is confirmed, in the system S, the list generating unit 13 assigns a selection flag to each of the selected tool components at S4. On the display unit 33, each of the selected tool components are checked or their display color is changed, and thus, the selected tool components are easily identified.

Next, the operator selects "assembly operation" as the action pattern at S5. At S6, the unique identification information of each of the tool components selected for planned assembly is actually read by the reader 32.

In the system S, the data determining unit 14 determines whether the unique identification information of each of the tool components selected for planned assembly matches the unique identification information of the tool component to which the selection flag is assigned in "assembly registration" or not at S7. Here, when the unique identification information does not match, an alarm is issued at S8. Accordingly, the operator can detect each of the read tool components is wrong, and selects correct tool components and reads the unique identification information again with the reader 32 at S6. When the unique identification information matches, a correct sound is issued at S7. However, not limited to issuing the correct sound, another output unit that allows confirming a successful operation, such as display on the display unit, may be employed, or the output when correct is not necessarily made (hereinafter, the same applies to the process of "the correct sound is issued").

Thus, reading of the unique identification information of the tool holder, the adapter, and the cutting tool as the tool components is completed, a record is made in the tool configuration information table 25 at S9, and an assembled tool ID is generated in the ID generating unit 12.

Accordingly, at S10, the operator executes an operation of forming an assembled tool by assembling the tool holder, the adapter, and the cutting tool that have completed to be read. After the end of the assembly operation, the operator inputs the end of the assembly operation at S11. When there still is an assembled tool to be assembled, the same process is repeated from the selection of the assembly registration returning to S1.

Next, the procedure of storing the assembled tool after assembly in the location to store will be described based on the flowchart in FIG. 3.

First, the operator selects "storage registration" as the action pattern from the input unit 31 of the information input/output terminal 2 at S21.

Then, in the system S, the display unit 33 displays the list of the assembled tool for which the assembled tool ID is generated and the location to store at S22.

Accordingly, the operator selects the assembled tool to be stored and its location to store on the list at S23. Then, in the system S, the list generating unit 13 assigns selection flags to the selected assembled tool and location to store at S24.

Next, the operator selects "storage operation" as the action pattern at S25. At S26, the unique identification information assigned to the tool component included in the assembled tool planned to be stored is actually read with the reader 32.

Then, in the system S, the data determining unit 14 determines whether the unique identification information assigned to the tool component included in the assembled tool planned to be stored matches the unique identification information of any of the tool components in the assembled tool to which the selection flag is assigned in "storage registration" or not at S27. Here, when the unique identification information does not match, an alarm is issued at S28. Accordingly, the operator can detect the read assembled tool is wrong, and selects a correct assembled tool and reads the unique identification information again with the reader 32 at S26. When the unique identification information matches, a correct sound is issued.

When the assembled tool is confirmed, the operator reads the unique identification information assigned to the location to store the assembled tool with the reader 32 at S29. Then, in the system S, the data determining unit 14 determines whether the unique identification information assigned to the location to store the assembled tool matches the location to store to which the selection flag is assigned in "storage registration" or not at S30. Here, when the locations to store do not match, an alarm is issued at S31. Accordingly, the operator can detect the read location to store is wrong, and selects a correct location to store and reads the unique identification information again with the reader 32 at S29. When the unique identification information matches, the state on the data becomes the stored state, and an address ID is recorded in the tool configuration information table 25 at S32. Thereafter, the operator executes the operation of storing the assembled tool in the location to store at S33.

Next, when the storage operation is terminated, the operator inputs the end of the storage operation at S34. When there is still an assembled tool to be stored, the same process is repeated from the selection of the storage registration returning to S21.

When the operation from the registration of the assembled tool to the storage is thus terminated, the operator creates a tool list for use that prepares the assembled tool used in machining when the NC program for each processed product type in the machine tool is created. The tool list for use is creatable by automatic generation based on a process sheet, for example, created by the operator specifying the assembled tool and the tool components to be used.

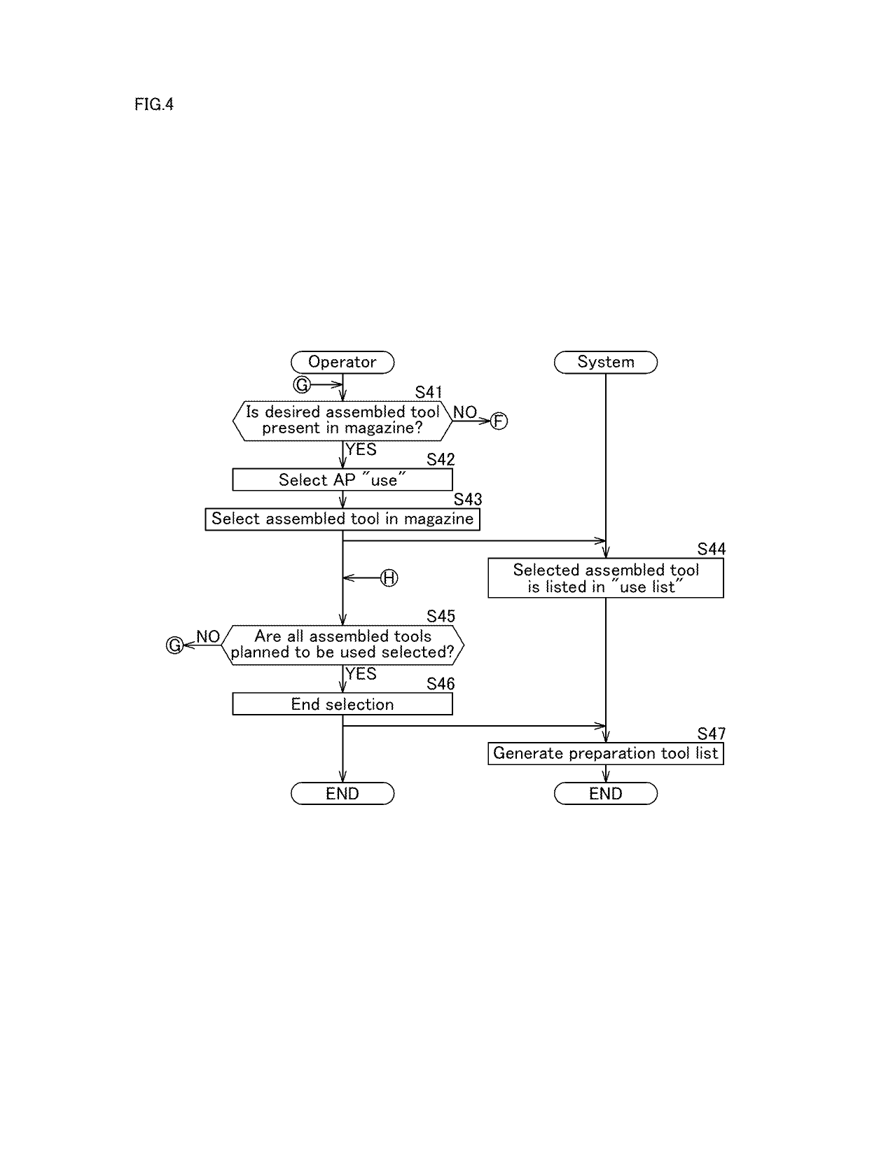

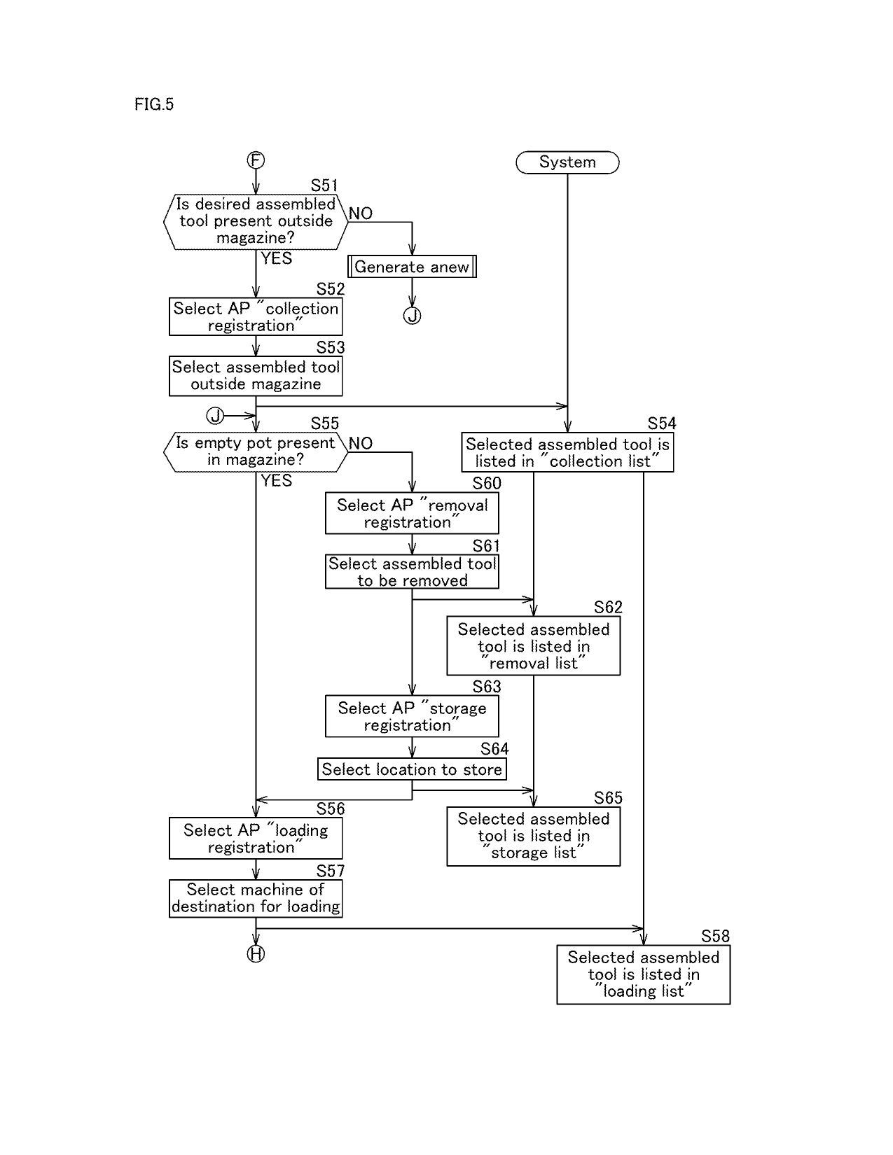

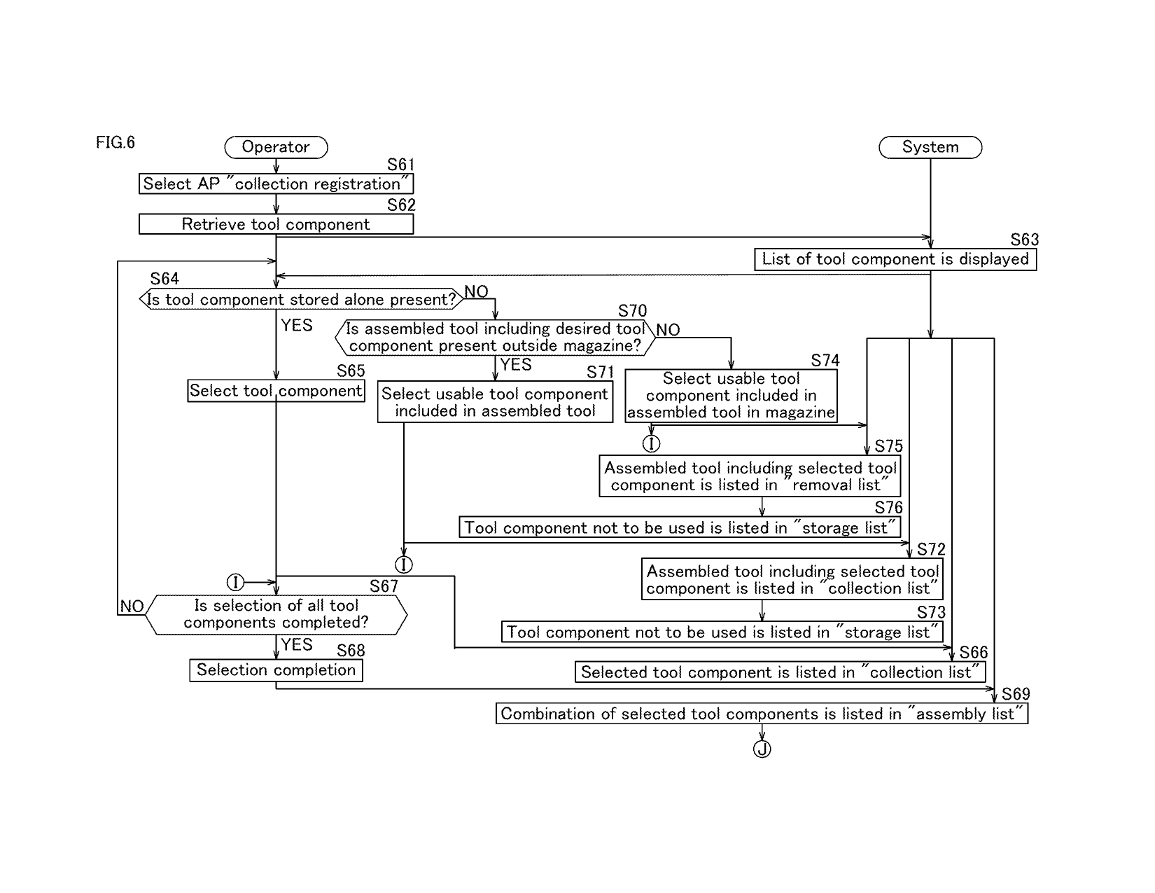

When the assembled tool of the tool list for use is not prepared in the magazine of the machine tool, the operator needs to perform a preparatory work of removing the assembled tool not to be used and storing it to the location to store, disassembling the assembled tool not to be used to collect the necessary tool components, and forming a new assembled tool and loading it in the magazine, or collecting the assembled tool stored in the location to store and loading it in the magazine, in order to prepare the assembled tool. In the preparatory work, a preparation tool list that summarizes the assembled tool or the tool components to be used into each action pattern on the data in the system S is generated, and the operation is performed based on the preparation tool list. The following describes the generation operation of the preparation tool list based on the flowcharts in, FIG.4 and FIG.5.

First, the operator calls up a list of tools in the magazine on the display unit 33, and confirms whether a desired assembled tool is present in the magazine on the data or not at S41. When the desired assembled tool is present here, the action pattern is selected to be "use" at S42. When the desired assembled tool is not present, the process proceeds to the flowchart in FIG. 5.

Next, the operator selects the assembled tool in the magazine on the data at S43. Then, in the system S, the selected assembled tool is listed in a "used list" at S44.

Next, the operator confirms whether all the assembled tools planned to be used are selected or not at S45. Here, when all the assembled tool planned to be used are selected, the selection completion is input at S46. Then, in the system S, the "used list" as a list of the selected assembled tools is generated as the preparation tool list, and the operation is terminated at S47. At S45, when all the assembled tools planned to be used are not selected, the process returns to S41.

On the other hand, when the desired assembled tool is not present in the magazine in the determination at S41, the operator confirms whether the desired assembled tool is present outside the magazine or not at S51 in FIG. 5. Here, when the assembled tool is present outside the magazine, the action pattern is selected to be "collection registration" at S52, and the assembled tool being outside the magazine is selected on the data at S53. Then, in the system S, the selected assembled tool is listed in the "collection list" at S54. When the desired assembled tool is not present also outside the magazine at S51, a new assembled tool is formed using the tool components. The details will be described below.

Next, the operator confirms whether an empty pot is present in the magazine of the machine tool that executes machining or not at S55. When the empty pot is present here, the action pattern is selected to be "loading registration" at S56, and the machine tool as a destination for loading is selected on the data at S57. Then, in the system S, the selected assembled tool is listed in an "loading list" at S58. Accordingly, returning to FIG. 4, when all the assembled tools planned to be used are selected at S45 and the end of the selection is input at S46, in the system S, the "collection list" and the "loading list" as the lists of the selected assembled tools are generated as the preparation tool lists at S47, and the operation is terminated.

When the empty pot is not present in the determination at S55, it is necessary to remove the unnecessary assembled tool to make an empty pot. Accordingly, the operator selects "removal registration" as the action pattern at S60, and selects the assembled tool to be removed on the data at S61. Then, in the system S, the selected assembled tool is listed in a "removal list" at S62. Next, the operator selects "storage registration" as the action pattern at S63, and selects the location to store on the data at S64. Then, in the system S, the selected assembled tool is listed in a "storage list" at S65. Accordingly, an empty pot is made on the data, and therefore, the operator is possible to select the machine tool of the destination for loading of the selected assembled tool in the process at S56 and S57, and list it on the "loading list" at S58. In this case, the system S also generates the "removal list" and the "storage list" that are lists of the assembled tool not to be used, in addition to the "collection list" and the "loading list" of the assembled tool to be used, as the preparation tool list, and terminates the operation at S47 in FIG. 4.

When the desired assembled tool is not present even outside the magazine in the determination at S51, it is necessary to newly collect the tool components and form the assembled tool. The following describes the operation of forming a new assembled tool based on the flowchart in FIG. 6.

First, the operator selects "collection registration" as the action pattern at S61. Next, the necessary tool components are input, and thus, retrieval is commanded at S62. Then, in the system S, a list of the tool components retrieved by the tool retrieval unit 15 is displayed at S63. Accordingly, the operator confirms whether a tool component stored alone is present or not at S64, and when the tool component is present, the tool component is selected on the data at S65. Then, in the system S, the selected tool component is listed in the "collection list" at S66.

Next, the operator confirms whether selection of all the tool components is completed on the data or not at S67. Here, when all the selection is completed, the selection completion is input at S68. Then, in the system S, the combination of the selected tool components is listed in an "assembly list" at S69, and the process returns to S55 in FIG. 5. When the destination for loading of thus combined assembled tool is selected, and the selection is terminated at S46 in FIG. 4, the system S also generates the "assembly list" of the tool components, in addition to the "collection list," "loading list," "removal list," and "storage list" of the assembled tool, as the preparation tool list at S47, and terminates the operation. When the selection of all the tool components is not completed at S67, the selection process of the tool components is repeated by returning the process to S64.

On the other hand, when the tool component stored alone is not present at S64, whether an assembled tool including the desired tool components is present outside the magazine or not is confirmed at S70. When the corresponding assembled tool is present here, the usable tool component included in the assembled tool is selected on the data at S71. Then, in the system S, the assembled tool including the selected tool component is listed in the "collection list" at S72, and the tool component not to be used is listed in the "storage list" at S73. The operator returns to the confirmation at S67.

When the corresponding assembled tool is not present outside the magazine and a usable tool component is present in the assembled tool not to be used in the magazine at S70, the operator selects the tool component at S74. Then, in the system S, the assembled tool including the selected tool component is listed in the "removal list" at S75, and the tool component not to be used is listed in the "storage list" at S76. The operator returns to the confirmation at S67.

When all the tool components are selected and listed in the "assembly list," the process returns to S55 in FIG. 5. When the destination for loading of thus combined assembled tool is selected, and the selection is terminated at S46 in FIG. 4, the system S also generates the "assembly list," "collection list," "removal list," and "storage list" of the tool components, in addition to the "collection list," "loading list," "removal list," and "storage list" of the assembled tool, as the preparation tool lists at S47, and terminates the operation.

Thus, the preparation tool list for preparing all the assembled tools in the tool list for use used in the NC program of the corresponding processed product type is automatically generated per action pattern.

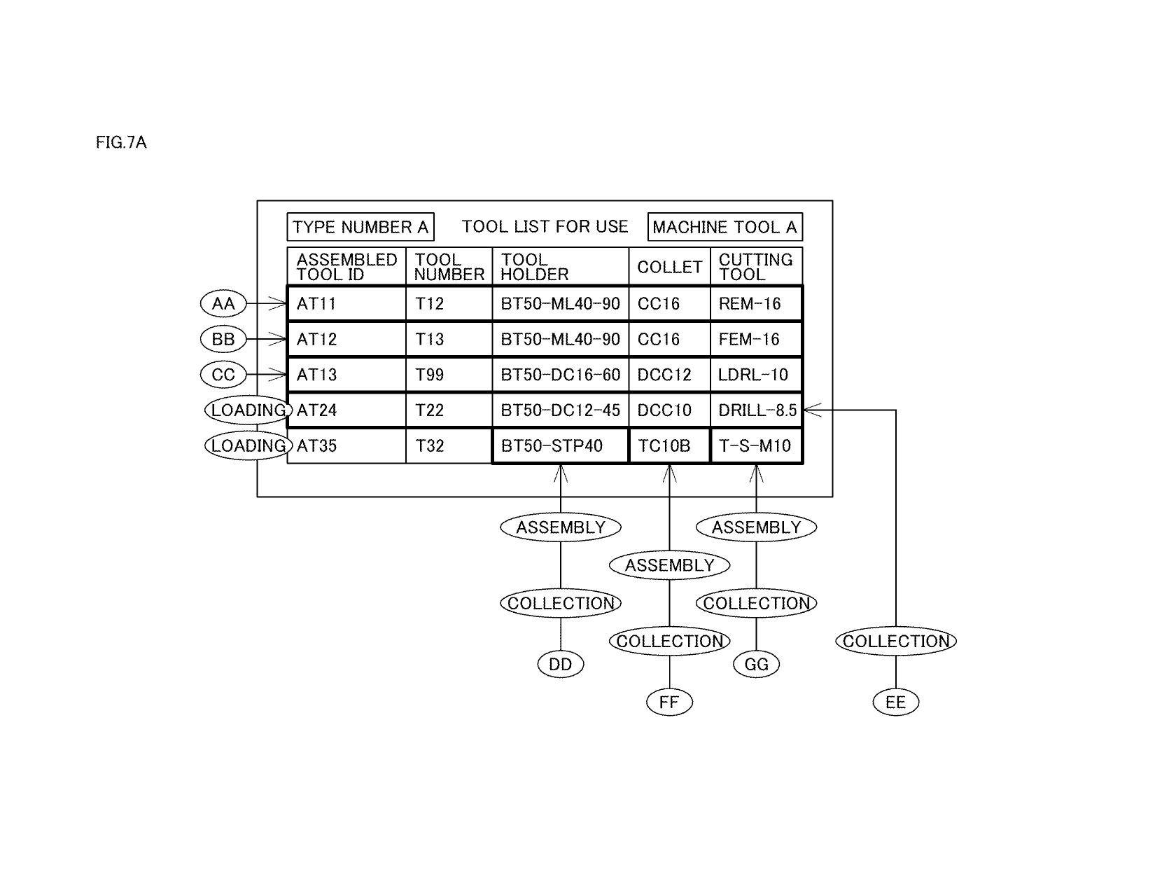

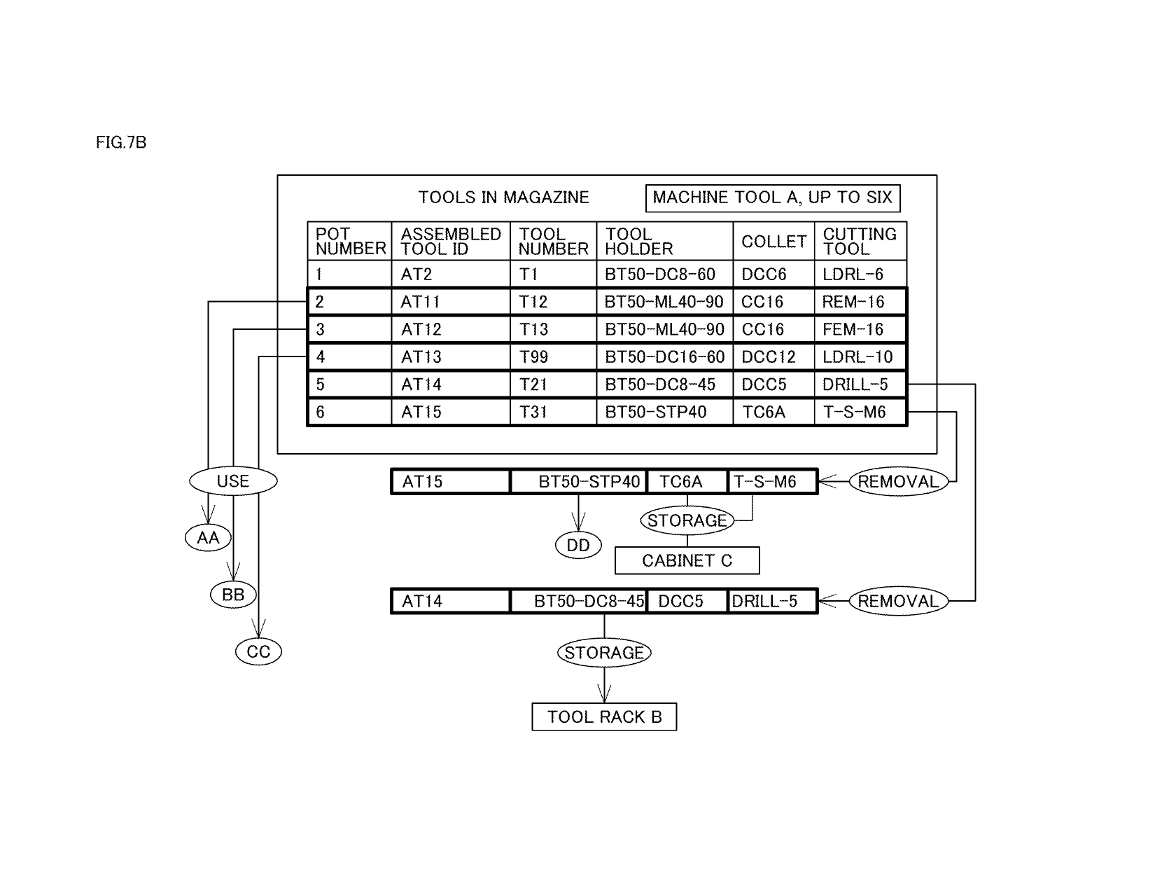

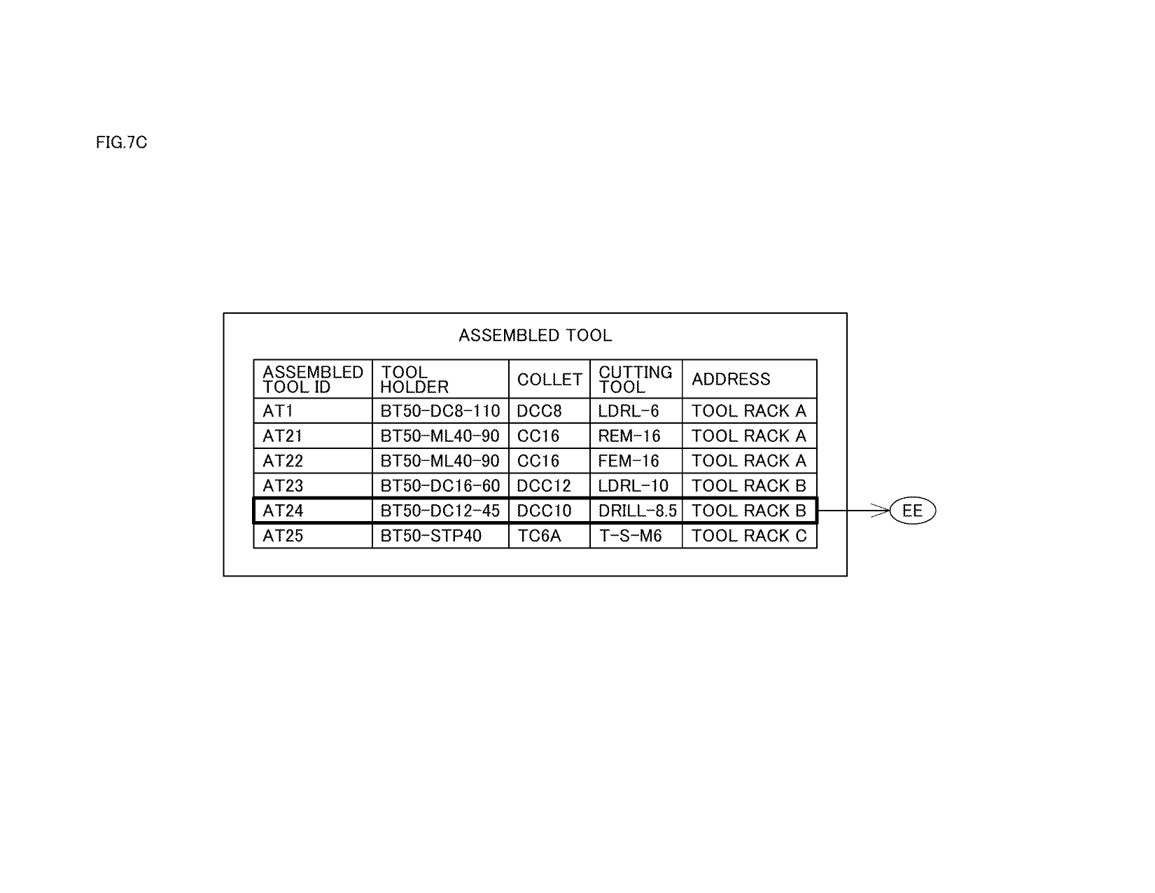

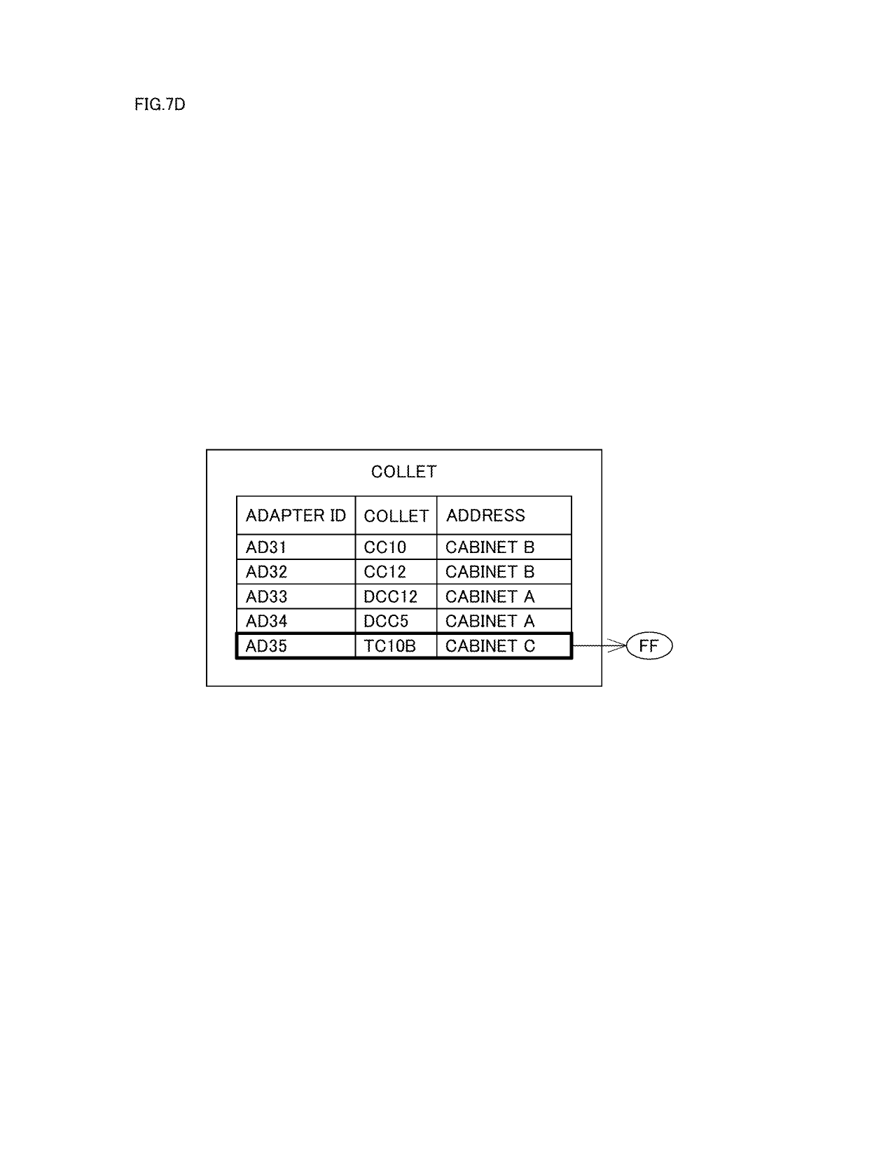

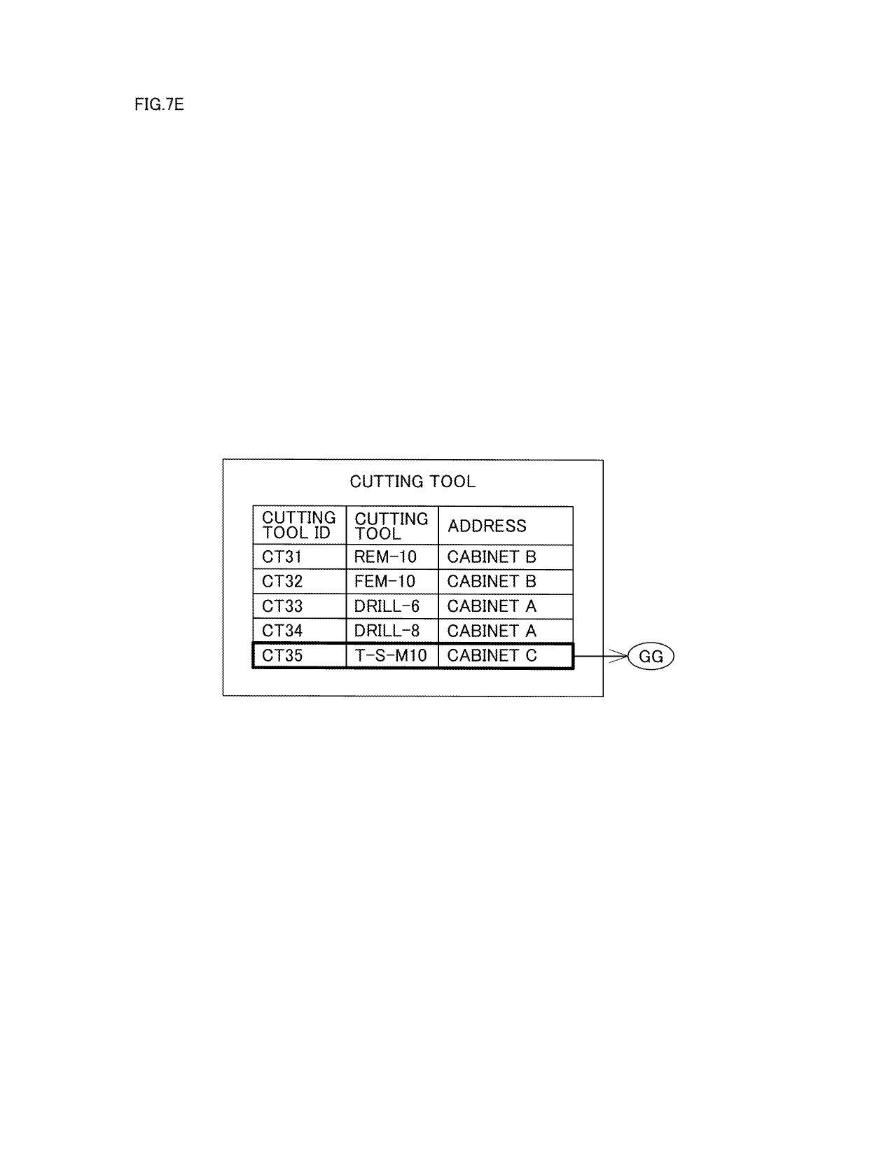

FIG. 7A illustrates a tool list for use generated from the tool information database 10, FIG. 7B illustrates a list of tools in the magazine, FIG. 7C illustrates a list of assembled tools outside the magazine, FIG. 7D illustrates a list of collets outside the magazine, and FIG. 7E illustrates a list of cutting tools outside the magazine. The characters surrounded by oval shapes indicate inclusion in the preparation tool list for each action pattern.

Here, assembled tools "AT11," "AT12," and "AT13" in the tool list for use in FIG. 7A have already been respectively loaded in pot numbers 2 to 4 as the tools in the magazine of a machine tool A, and therefore, it is indicated that they are directly selected as the used tools and listed in the used list (S41 to S44 and S47 in FIG. 4).

An assembled tool "AT24" in the tool list for use is stored in a tool rack B among the assembled tools outside the magazine in FIG. 7C, and therefore, it is indicated that the assembled tool "AT24" is selected and is listed in the collection list, and is listed in the loading list for the machine tool A (S51 to S58 in FIG. 5).

Furthermore, in order to make an empty pot, it is indicated that an assembled tool "AT14" of a pot number 5 not to be used is selected among the tools in the magazine in FIG. 7B and listed in the removal list, and is listed in the storage list for the tool rack B selected as the location to store (S60 to S65 in FIG. 5).

Meanwhile, in FIG.7A to FIG.7E, in order to form a new assembled tool "AT35" in the tool list for use, a usable tool holder "BT50-STP40" is selected from the assembled tool "AT15" in the pot number 6 among the tools in the magazine in FIG. 7B. Accordingly, it is indicated that the assembled tool "AT15" is listed in the removal list, the selected tool holder "BT50-STP40" is listed in the collection list as a single tool holder, and other than those, a collet "TC6A" and a cutting tool "T-S-M6" not to be used are listed in a storage list for a cabinet C (S74 to S76 in FIG. 6).

It is indicated that among the collets in FIG. 7D, a collet "TC10B" stored in the cabinet C is selected and listed in the collection list (S64 to S66 in FIG. 6), among the cutting tools in FIG. 7E, a cutting tool "T-S-M10" stored in the cabinet C is selected and listed in the collection list (S64 to S66 in FIG. 6). It is indicated that the collet "TC10B" and the cutting tool "T-S-M10" are listed in the assembly list for forming the assembled tool "AT35" with the tool holder "BT50-STP40" similarly listed in the collection list, and are listed in the loading list for the machine tool A (S69 in FIG. 6 and S55 to S58 in FIG. 5).

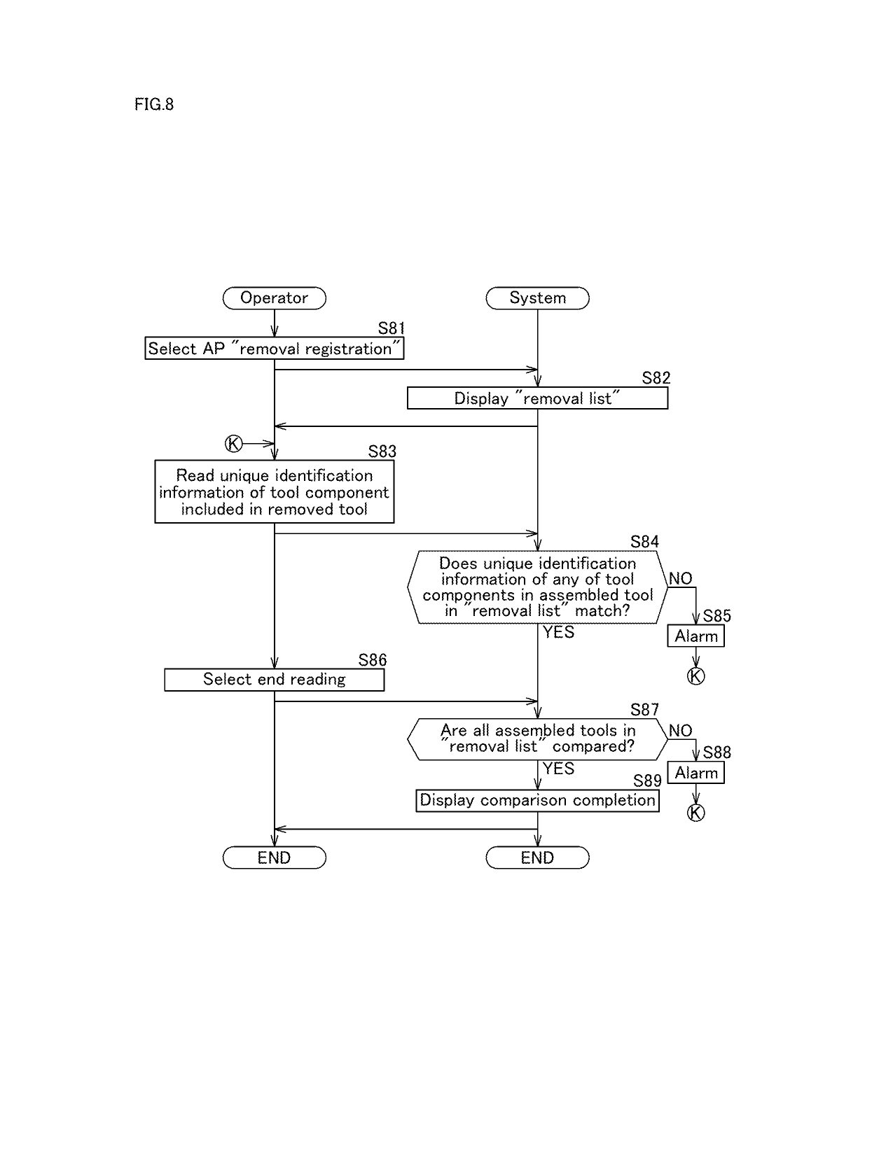

Accordingly, the operator actually removes the tool components and the assembled tool at a movement origin based on each of the generated preparation tool lists, and performs the operation of moving the tool components and the assembled tool to a movement destination. The operation is described using the removal operation of the assembled tool in FIG. 8 as an example.

First, the operator selects "removal registration" as the action pattern at S81. Then, in the system S, the "removal list" of the assembled tools is displayed on the display unit 33 at S82.

Accordingly, the operator removes the assembled tools on the list, and actually reads the unique identification information assigned to any of the tool components in the assembled tool with the reader 32 at S83.

Then, in the system S, the data determining unit 14 determines whether the unique identification information assigned to any of the tool components in the assembled tool matches the unique identification information of any of the tool components in the assembled tool in the "removal list" or not at S84. Here, when the unique identification information does not match, an alarm is issued at S85. Accordingly, the operator can detect the read assembled tool is wrong, and selects a correct assembled tool and reads the unique identification information again with the reader 32 at S83. When the unique identification information matches, a correct sound is issued.

The comparison with the removal list is thus performed, and as soon as the operator inputs the end of the reading at S86, a determination of whether all the assembled tools in the "removal list" are compared or not is made in the system S at S87. Here, when the comparison of all the assembled tools is not performed, an alarm is issued at S88. Accordingly, the operator can detect that the assembled tool that has not been compared is still present, and reads the unique identification information of the assembled tool not compared with the reader 32 at S83. When all the assembled tools are compared at S87, the comparison completion is displayed and the removal operation is terminated at S89.

Similarly, also in the storage, collection, assembly, and loading, the unique identification information of the assembled tool or the tool component is actually read with a corresponding operation being selected as the action pattern, and an operation of comparing with the storage list, the collection list, the assembly list, and the loading list is performed. In the "storage operation," the tool component or the assembled tool listed in the "storage list" is stored in a predetermined location to store after comparing with the unique identification information. In the "collection operation," the tool component or the assembled tool listed in the "collection list" is collected after comparing with the unique identification information. In the "assembly operation," the tool component collected and listed in "assembly list" forms an assembled tool being assembled after comparing with the unique identification information. In the "loading operation," the assembled tool listed in the "loading list" is loaded in the magazine of the machine tool after comparing with the unique identification information.

Thus, the system S having the above-described configuration includes the tool management device 1 having the tool information database 10 that stores the information relating to the assembled tool assembled at least including the tool holder and the cutting tool as the tool components, the information relating to each of the tool components, and the information relating to the location to store the assembled tool and each of the tool components, and the information input/output terminal 2 able to input/output data to/from the tool management device 1.

The tool management device 1 stores each piece of the unique identification information in the tool information database 10 by associating each piece of the unique identification information to each of the tool components or the assembled tool or each of the locations to store, as soon as the unique identification information assigned to each of the tool components, the assembled tool, and each of the locations to store is input via the information input/output terminal 2.

In the information input/output terminal 2, the tool component and/or the assembled tool stored in the tool information database 10 is selectable together with a plurality of the predetermined action patterns representing the actual operations necessary for preparing the assembled tool used in machining with the machine tool.

The tool management device 1 includes the list generating unit 13 that automatically generates the preparation tool list including the selected tool components and/or assembled tool per action pattern as soon as the tool component and/or the assembled tool is selected together with each of the action patterns by the information input/output terminal 2, and the data determining unit 14 that determines whether the unique identification information of the actual tool component and/or assembled tool input by the information input/output terminal 2 matches the unique identification information of the tool component and/or the assembled tool listed in the preparation tool list or not.

The configuration allows for precisely performing the actual operation of converting the assembled tool and its tool components, and the location to store into data by respectively assigning the unique identification information, generating the preparation tool list by selecting the predetermined action pattern on the data when the NC program is created, and preparing the assembled tool based on the preparation tool list while comparing the movement origin with the movement destination by means of the unique identification information. Accordingly, even when the system manages the assembled tool, the configuration of the assembled tool necessary for machining and the location thereof are obtainable, and thus, the necessary assembled tool is reliably preparable in a short time.

The action patterns are the removal of the assembled tool not to be used from the machine tool, the storage of the tool component and/or the assembled tool in the location to store, the collection of the tool component and/or the assembled tool, the assembly of each tool component for forming an assembled tool, and the loading of the assembled tool in the machine tool, and the list generating unit 13 automatically generates the removal list when the action pattern selected by the information input/output terminal 2 is the removal, the storage list when the action pattern selected by the information input/output terminal 2 is the storage, the collection list when the action pattern selected by the information input/output terminal 2 is the collection, the assembly list when the action pattern selected by the information input/output terminal 2 is the assembly, and the loading list when the action pattern selected by the information input/output terminal 2 is the loading as the respective preparation tool lists.

Accordingly, the operation necessary for the assembled tool and the tool component that need to move is easily obtainable.

The tool information database 10 includes the cutting tool information table 22 that at least stores the service life information of the cutting tool and the tool configuration information table 25 that stores the information relating to the assembled tool, when the cutting tool is assembled to the tool holder, and an assembled tool is formed, the service life information stored in the cutting tool information table 22 is copied in the tool configuration information table 25, the copied service life information is updated corresponding to the used time or the count of use as the assembled tool, and when the cutting tool is removed from the tool holder, the service life information of the cutting tool information table 22 is updated corresponding to the service life information updated in the tool configuration information table 25.

Accordingly, even though the cutting tool is replaced, the service life information is succeeded, thus allowing for accurate service life management.

The following describes a modification of the disclosure.

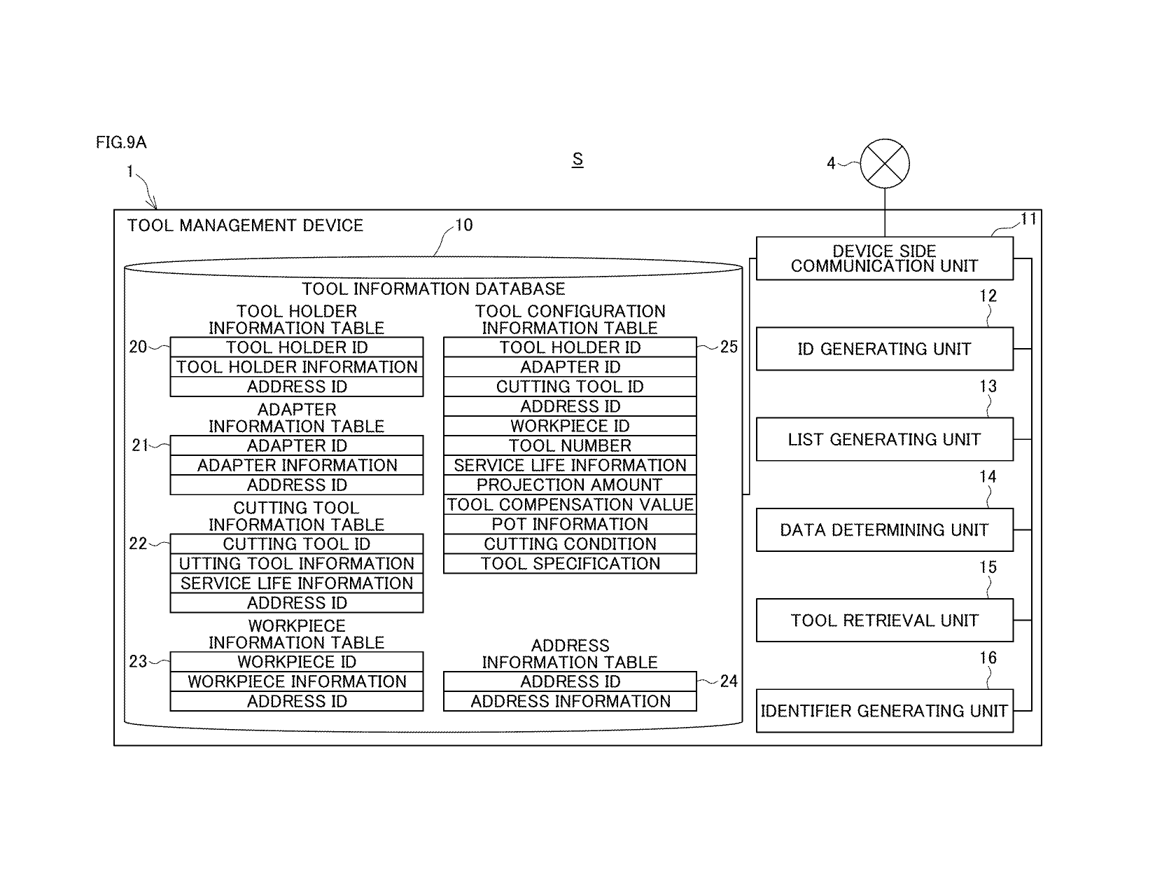

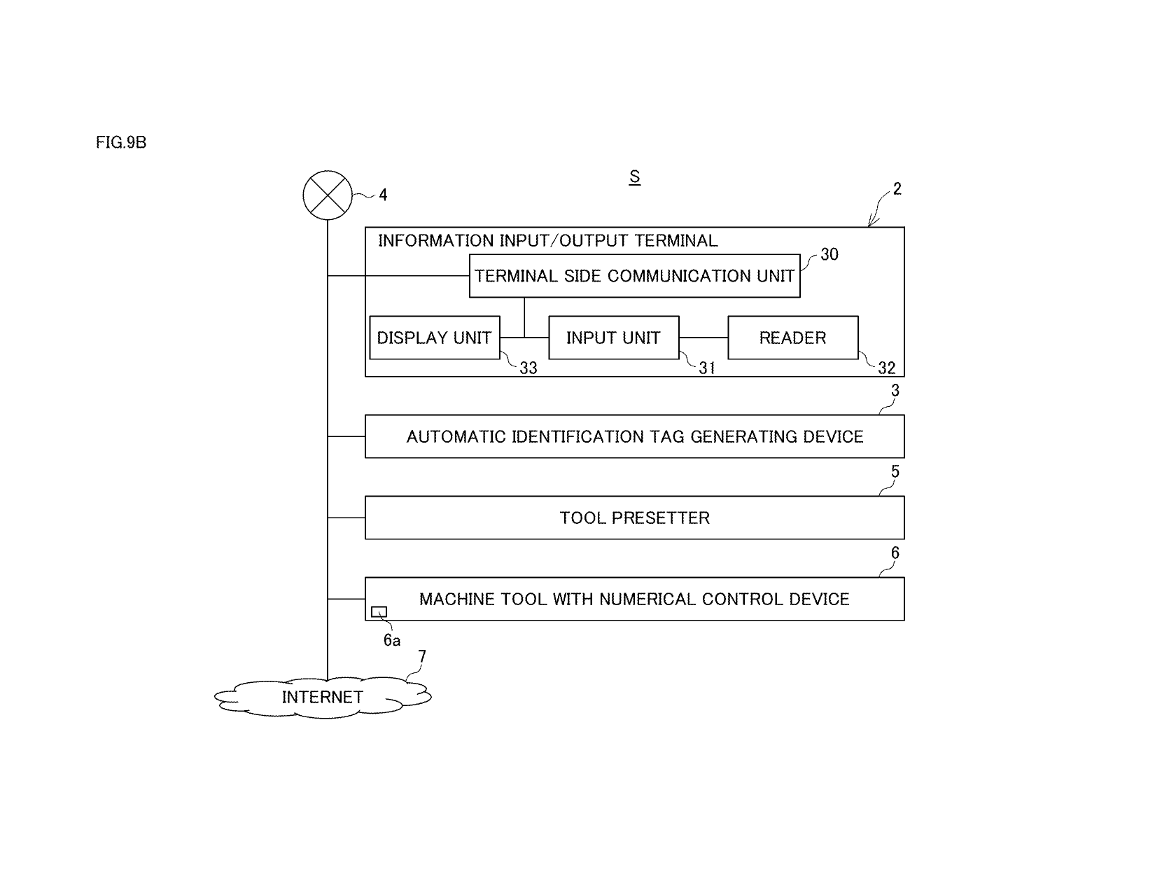

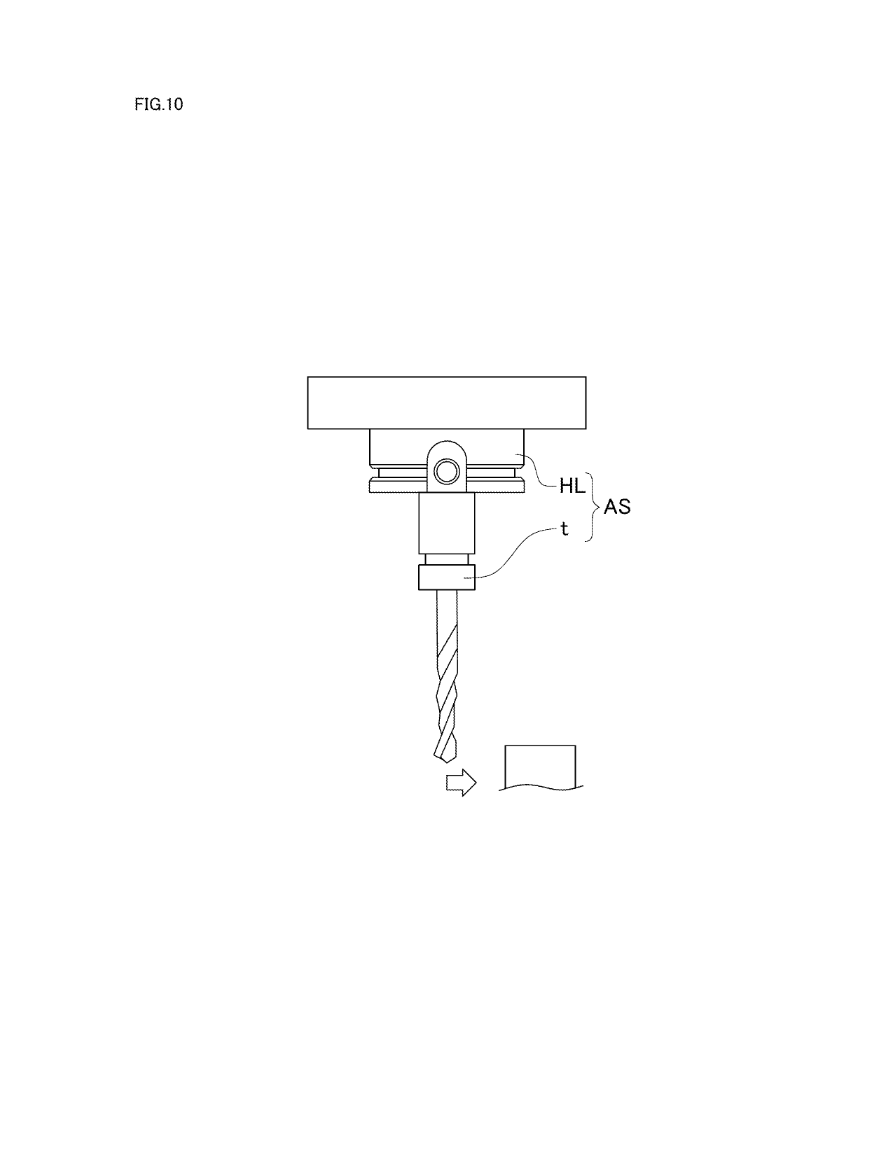

FIGS. 9A and 9B illustrate a modification of the tool management system S. The configuration units the same as those in FIG. 1 are the same as those in the above-described configuration, and therefore, the explanation is omitted.

Here, an identifier generating unit 16 is provided in the tool management device 1, and the unique identification information is automatically generatable by the identifier generating unit 16. A tool presetter 5 and a machine tool 6 provided with a numerical control device are coupled via the network 4.

The tool configuration information table 25 is able to respectively store a projection amount of the cutting tool, a tool compensation value obtained by measuring the tool with the tool presetter 5, pot information including the pot numbers of the tool magazine of the machine tool 6, cutting conditions, and tool specifications.

The machine tool 6 is provided with a reader 6a for reading the automatic identification tags of the tool holders when the assembled tool is mounted in the tool magazine. Accordingly, by obtaining the pot information including the pot number indicating the mount position, and managing it by associating with the assembled tool ID when the assembled tool is mounted in the tool magazine, the tool compensation value measured with the tool presetter 5 can be accurately input in the machine tool 6. Besides, by obtaining the service life information from the machine tool 6 and managing it by associating with the assembled tool ID, appropriate service life management can be performed.

Furthermore, by managing the cutting conditions and the tool specifications by associating with the assembled tool ID, not only setting of the appropriate cutting conditions being enabled when the program is generated, but also linking with an automation system using a robot is enabled. By coupling the network 4 to Internet 7, the latest and accurate information is always available.

In the tool management systems of the above-described configuration and the modification, the assembled tool and the tool component selected when the NC program is created may be optionally assigned with a reservation flag when being selected so as to inhibit the assembled tool and the tool component assigned with the reservation flags from being selected by another operator. Thus, assigning the reservation flag inhibits the assembled tool and the tool component from being taken away by another operator, and thus, the assembled tool and the tool component are available.

When the tool holder and the cutting tool are selected, the system may uniquely determine an adapter to be used. In such a case, the system displays a list of locations to store the target adapter, and rearranges the locations to store by distance from the machine tool in which the adapter is loaded to the locations to store, displays detailed information of the location to store including a map and an image by selecting the candidate, and thus, navigation to the location to store may be provided. Similarly, address information other than the adapter may also serve as a navigation.

In the tool management system, establishing a database within a range where the tool component and the assembled tool are used in common allows for managing a plurality of machine tools irrespective of the type of the control device.

When the cutting tool is separated into a body and an insert and managed, respective IDs may also be assigned to the body and the insert and may be managed as a tool component.

The assembled tool of the disclosure also includes a combination of an "integral holder" as the tool holder of the disclosure in which a shank portion and a cutter body are integrated and an "insert" as the cutting tool of the disclosure. Accordingly, in the case, respective IDs may be assigned to the integral holder and the insert, and managed as a tool component.

The action patterns are not limited to the above-described configuration. For example, when the assembled tool in the magazine is directly used, the selection of the action pattern "use" is not necessarily present.

On the other hand, while in the above-described configuration and the modification, the information input/output terminal that serves as an information input/output unit is provided separately from the tool management device, and the information input/output terminal and the tool management device are coupled via the network, and thus, the tool management system is formed, the information input/output unit may be provided in the tool management device itself so as to be able to directly input/output the data.

While in the above-described configuration and the modification, in order to input the unique identification information, the reader provided in the input unit is employed, the input unit is not limited to the reader, and may be a keyboard or the like provided in the input unit. That is, when the unique identification information is provided as numbers or characters, the numbers or the like are simply input using the keyboard or the like.

While in the above-described configuration and the modification, the description is made using the example of generating and managing the assembled tool ID, the tool management system of the disclosure works without managing the assembled tool ID, and therefore, the assembled tool ID is not necessarily generated.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A tool management system comprising:
a tool management device having a tool information database that stores information relating to an assembled tool assembled at least including a tool holder and a blade as tool components, information relating to each of the tool components, and information relating to locations to store the assembled tool and each of the tool components; and
an information input/output unit that is able to input/output data to/from the tool management device, wherein
the tool management device stores each piece of the unique identification information in the tool information database while associating each piece of the unique identification information to each of the tool components, the assembled tool, or each of the locations to store when inputting each piece of unique identification information assigned to each of the tool components, the assembled tool, and each of the locations to store is performed via the information input/output unit, and
in the information input/output unit, the tool component and/or the assembled tool stored in the tool information database is selectable together with a plurality of predetermined action patterns representing actual operations necessary for preparing an assembled tool used in machining with a machine tool, wherein
the tool management device includes:
a list generating unit that automatically generates a preparation tool list including the selected tool component and/or assembled tool for each of the action patterns when the tool component and/or the assembled tool is selected together with each of the action patterns by the information input/output unit; and
a data determining unit that determines whether the unique identification information of the actual tool component and/or assembled tool input by the information input/output unit matches the unique identification information of the tool component and/or the assembled tool listed in the preparation tool list or not.

2. The tool management system according to claim 1, wherein
the action patterns are, at least, i) removal of the assembled tool not to be used from the machine tool, ii) storage of the tool component and/or the assembled tool in the location to store, iii) collection of the tool component and/or the assembled tool, iv) assembly of each of the tool components to form the assembled tool, and v) loading of the assembled tool to the machine tool, and
the list generating unit automatically generates a removal list when the action pattern selected by i), a storage list when the action pattern selected by ii), a collection list when the action pattern selected by iii), an assembly list when the action pattern selected by iv), and a loading list when the action pattern selected by v), as the respective preparation tool lists.

3. The tool management system according to claim 1, wherein
the tool information database includes a blade information table that at least stores service life information of the blade, and a tool configuration information table that stores information relating to the assembled tool; and
when the blade is assembled to the tool holder, and the assembled tool is formed, the service life information stored in the blade information table is copied in the tool configuration information table, the copied service life information is updated corresponding to a used time or a count of use as the assembled tool, and when the blade is removed from the tool holder, the service life information of the blade information table is updated corresponding to the service life information updated on the tool configuration information table.
